(19) United States
(12) Patent Application Publication
(10) Pub. No.: US 2004/0044868 A1
(43) Pub. Date: Mar. 4, 2004

(54) Method and apparatus for high-speed longest prefix match of keys in a memory

(75) Inventor: Miguel A. Guerrero, Freemont, CA (US)

Correspondence Address: Pillsbury Winthrop LLP, Intellectual Property Group, 725 South Figueroa Avenue, Los Angeles, CA, 90017, US

(73) Assignee: Intel Corporation, Santa Clara, CA

(21) Appl. No.: 10/232,985

(22) Filed: Aug. 30, 2002

(51) Int. Cl. G06F 12/14

(52) U.S. Cl. 711/164; 711/5

(57) ABSTRACT

An address look-up device includes a search device and a Discriminant Bits (DB)/Longest Prefix Match (LPM) search device. The search device receives an input key and determines one of at least one memory section of a memory device in which to search for a resultant key having a longest prefix matching the input key. The DB/LPM search device receives the input key and the memory reference, and utilizes a DB pattern and a set of LPM rules to determine and provides a determined key.

### RELATED APPLICATION

This application is related to U.S. patent application Ser. No. ______ filed on ______, entitled “METHOD AND APPARATUS FOR ADDRESS LOOKUP”.

### BACKGROUND

1. Technical Field

An embodiment of this invention relates to the field of address look-ups, and more specifically, to a system, method, and apparatus to receive a packet having an input key and perform a longest prefix match search to determine a matching key having forwarding information associated therewith.

2. Discussion of the Related Arts

Internet Protocol (IP) packets are sent between routers and switches or nodes on the Internet. The packets include a packet payload as well as a packet header. The packet payload includes the data sent across the Internet. The packet header includes information about the format of the packet, the IP end destination address of the packet, as well as a key used to represent the next destination (also known as the “next hop” information) of the packet. As a packet is routed over the Internet, it travels from a starting location, then is transferred among switches at nodes, until it is finally sent to the end destination. The packet includes information about the end destination as well as information about the next place it is to be routed (i.e., the “next hop”). After the packet is received at a switch or node, a key is extracted therefrom. The key can be utilized to determine the next hop information.

Once the packet is received at a switch or node on the Internet, the key is removed and matched with a set of keys stored in a address look-up table. If a matching key is found, the next hop information associated with that key is acquired via reference to the address look-up table, and is added to the packet header. The packet is then sent to the next hop address.

There are systems in the art that perform Longest Prefix Match (LPM) searches to determine the key in a memory that has the longest prefix matching the key of the packet. For example, if the packet's key is 10 bits long, the key is compared with keys stored in the memory. If a key is located that has a 5-bit prefix matching the key, and another key is located that has a 10-bit prefix matching the key, the key with the 10-bit prefix would be selected because it has the longest prefix matching that of the packet's key. The prefix of a key includes the important bits that must be matched. For example, if a 10-bit key has a 5-bit prefix, the 10-bit key matches an input packet's key if the 5 most significant bits match those of the packet's key, independent of the remaining bits of the 10-bit key.

Binary search and tree based search schemes are used by some current systems to locate matching keys and determine the destination address for a packet. However, such search methods can become very slow when large numbers of keys are searched. For example, binary search schemes require adding 2 entries per LPM route. Therefore, memory efficiency is no greater than 50%. Tree-based schemes have the overhead of pointers. Accordingly, memory efficiency is also low.

Current systems for performing address look-ups (i.e., matching an input key with an IP address in a address look-up table) such as ternary Content Addressable Memory (CAM) devices are also slow and expensive. Moreover, current systems are intended for software execution and are not optimized for hardware. They extensively use search trees and pointers to locate matching keys. The use of such trees and pointers are often not hardware-friendly because many of them are very memory inefficient and others cannot be pipelined to achieve a high throughput. This is the case because pointers (to forwarding information) for a 64K table can be about 16 bits. Keeping this information for each entry or node in a tree (several of these may be needed) for a 32-bit IP address results in about 200% overhead in memory.

### BRIEF DESCRIPTION OF THE DRAWINGS

FIG. 1A illustrates an address look-up device according to an embodiment of the invention;

FIG. 1B illustrates a process to receive a packet, look up its destination address, and forward the packet to the destination address according to an embodiment of the invention;

FIG. 2A illustrates a memory according to an embodiment of the invention;

FIG. 2B illustrates a memory section of the memory according to an embodiment of the invention;

FIG. 3A illustrates a method utilized to determine a section of the memory in which to search for a resultant key having the longest prefix matching an input key;

FIG. 3B illustrates an implementation of a method utilized to determine a section of the memory in which to search for a resultant key having the longest prefix matching the input key;

FIG. 4 illustrates a table of keys stored in the memory according to an embodiment of the invention;

FIG. 5 illustrates an additional key table and a Discriminant Bit (DB) array according to an embodiment of the invention;

FIG. 6 illustrates a resultant key and pointer table according to an embodiment of the invention;

FIG. 7A illustrates a first portion of a method to determine and add dummy entries for nested keys to the memory storing the resultant keys, and the rules associated therewith, according to an embodiment of the invention;

FIG. 7B illustrates a second portion of a method to determine and add dummy entries for nested keys to the memory storing the resultant keys, and the rules associated therewith, according to an embodiment of the invention; and

FIG. 8 illustrates a rule-adding device to add LPM rules to a DB/LPM memory according to an embodiment of the invention; and

FIG. 9 illustrates two memory sections of the memory according to an embodiment of the invention.

### DETAILED DESCRIPTION

An embodiment of the present invention may provide a key (or address) lookup device to search for a key having the longest prefix matching a key of a packet. Longest Prefix Match (LPM) is a function that may be required by routers to support Classless InterDomain Routing (CIDR). CIDR is an addressing scheme that employs supernet addresses to represent multiple Internet Protocol (IP) destinations. A supernet is a group of networks identified by contiguous network addresses. Rather than advertise a separate route for each destination in a supernet, a router may use a supernet address to advertise a single route—called an aggregate route—that represents all of the destinations. This may reduce the size of routing tables used to store advertised IP routes.

An embodiment of the invention may include a pipelined binary search device to perform a binary search on a set of memory addresses, each of which is representative of a section of an external memory in which keys may be stored sequentially. After the pipelined binary search device locates a section of the memory in which the searched-for key may be located, a Discriminant Bits (DB)/LPM searching device may be utilized to locate (a) the key having the longest prefix matching the search key, or (b) a default key if no key having a prefix matching the search key is located within the memory. The DB/LPM search device performs a streamlined search based on the most significant bit that differs from a stored key and the key preceding it in the memory. Once a key is located (the default or the key having the longest prefix) by the DB/LPM search device, an Internet Protocol (IP) address stored within an IP Routing Table may be matched with the key and may be used to route a packet to the next-hop IP address. In other embodiments, network addresses other an IP may be utilized.

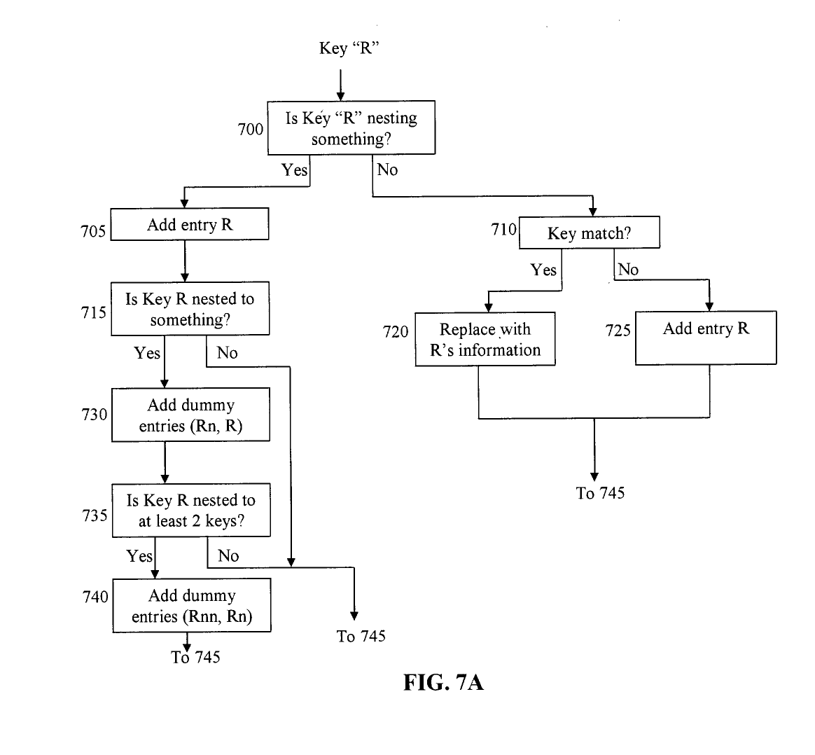

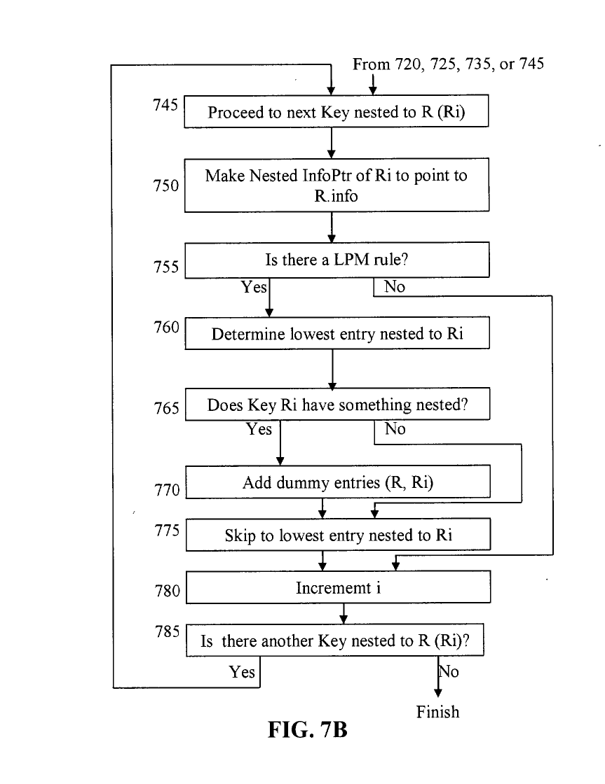

Each key stored in the memory may have a pointer associated therewith. The pointer may indicate the prefix length of the key, the length of the prefix of a key to which the key is nested (a first key is nested to a second key if the second key has a prefix shorter than a prefix of the first key, and the bits forming the prefix of the second key are also located in the first key), as well as the name of the nesting key, if there is one, for example. The system may also provide a method for determining when dummy entries must be added to perform the LPM search on keys having more than one nesting level. The dummy entries may be utilized to select the key having the longest matching prefix from among a set of keys having common prefixes, as explained below with respect to FIGS. 7A and 7B. The system may also provide a method for adding new keys to an address look-up table in the memory. The method may be utilized to add pointers to rules associated with each key in the address look-up table. The rules may contain forwarding information for the keys.

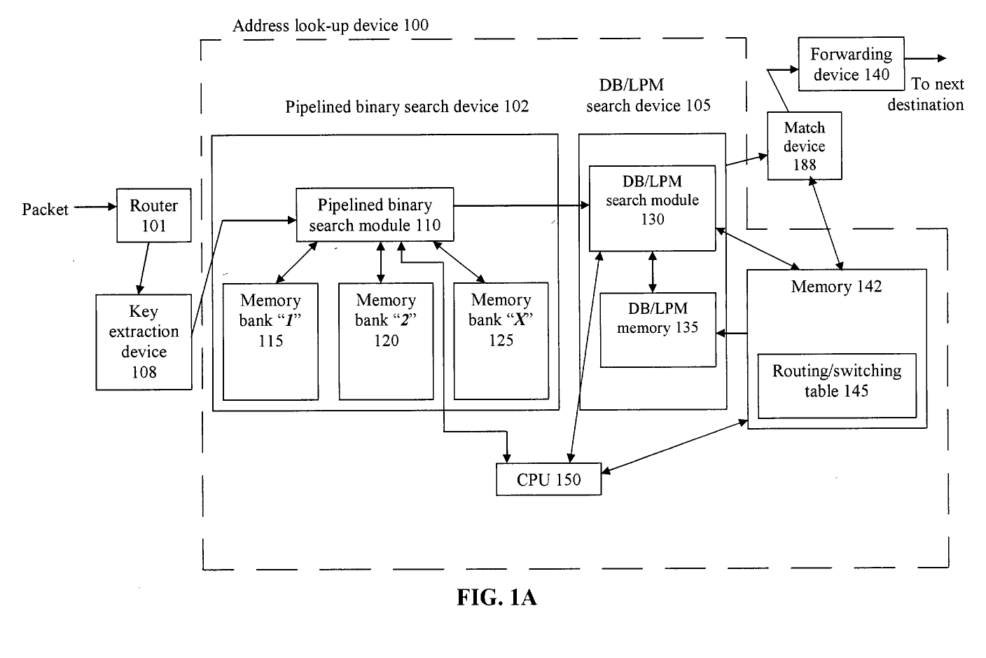

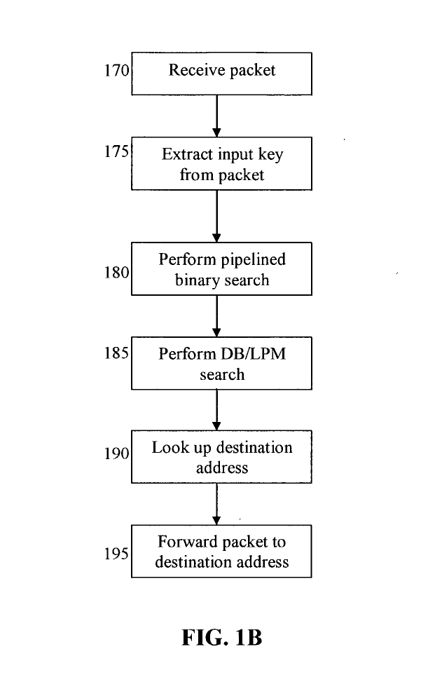

FIG. 1A illustrates an address look-up device 100 according to an embodiment of the invention. The address look-up device 100 may include a pipelined binary search device 102, a DB/LPM search device 105, and a memory 142. A router 101 may receive a packet and determine the next path in the packet's travel (i.e., the “next hop” information). In other embodiments, a Local Area Network (LAN) switch may be used instead of a router 101. In some embodiments, the address look-up device 100 may be separate from the router 101. In other embodiments, the address look-up device 100 may be housed within the router 101. The key may be a binary number that represents the next hop information for the packet. The packet may be an Ethernet packet or an Infiniband packet, for example. The packet may be received from a network such as the Internet, a LAN, a Wide Area Network (WAN), or any other suitable network. Similarly, the packet may be transmitted over the Internet, a LAN, a WAN, or any other suitable network to the next network device.

The router 101 may receive the packet and then send the packet to a key extraction device 108 which may extract an input key (the input key may be an address, for example) from the packet. In other embodiments, the router 101 may directly extract the input key. The input key may be utilized to determine the next hop address of the packet. The address look-up device 100 may include a memory 142 having a address look-up table 145. The address look-up table 145 may be a table of keys, each of which is associated with a next hop address. Accordingly, the address look-up table 145 may be utilized to determine a next hop address for the packet based on its input key. Once the input key has been matched up with a next hop address in the address look-up table 145 by a match device 188, the packet may then be forwarded to the next hop address by a forwarding device 140. The forwarding device 140 may be a router or a switch, for example.

When a packet is initially received by the router 101, the packet may then be sent to a key extraction device 108, which may extract the input key and supply it to the pipelined binary search module 110 of the pipelined binary search device 102 of the address look-up device 100. The pipelined binary search module 110 may be controlled by a processor such as Central Processing Unit (CPU) 150, for example. The pipelined binary search module 110 may have a function of determining a section of the memory 142 in which to search for a resultant key having the longest prefix matching the input key of the received packet. The memory 142 may include a plurality of memory sections in which resultant keys are located. The resultant keys may each be stored in a record in the memory 142. Each record may include the resultant key and a pointer to forwarding information associated with that resultant key (e.g., routing information), as well as forwarding information associated with an additional key to which the resultant key is nested, if there is one, as discussed below with respect to FIGS. 7A and 7B. Each of the resultant keys may be associated with a next hop address in the address look-up table 145. In an embodiment, the address look-up table 145 may be stored within the memory 142. In other embodiments, the address look-up table 145 may be located external to the memory 142. Also, in an embodiment, the memory 142 may be included within the address look-up device 100. In other embodiments, the memory 142 may be located external to the address look-up device 100.

The resultant keys stored within the memory 142 may each be formed of a plurality of bits. The function of the address look-up device 100 may be to locate the resultant key having the longest prefix matching the input key of the received packet. A prefix is a portion of a resultant key that is utilized to select the resultant key to match with the input key. For example, the following resultant keys may be located within the external memory 142:

| | |
|---|---|
| resultant key A | 0101 1101 |
| resultant key B | 0011 xxxx |
| resultant key C | 0011 1000 |

Resultant key B is said to have the prefix “0011”, and the other “4” bits, i.e., “xxxx” are each “don't care” bits. In other words, resultant key B may be matched with an “8” bit input key in which the first “4” bits are “0011”, regardless of what the last “4” bits are. (The last four bits of resultant key B are listed as “x” solely to illustrate how a key having the longest prefix is matched with it. In practice, the system may use a “1” to represent each “x” “don't care bit,” but may have knowledge of which “1” bits are “don't care” bits.) The system may be configured to match the input key with the resultant key having the longest matching prefix. Resultant key “A” has a prefix that is “8” bits long, the entire length of the resultant key. Resultant key B has a “4” bit prefix, and resultant key. “C” has an “8” bit prefix, the entire length of the key. Resultant key A may only match with an input key having the value “0101 1101”, which is equal to the value of resultant key A's prefix. Resultant key B may only match up with an input key having the first “4” bits “0011”, regardless of what the last “4” bits of the input key are. Similarly, resultant key C may only match up with an input key having the value “0011 1000”, which is the value of resultant key C's prefix. However, in an LPM search, an input key may only match with at most one resultant key, the resultant key having the longest prefix matching the input key. Accordingly, resultant key B may match with all input keys having the first “4” bits “0011” except for an input key “0011 1000”, which is equal to the value of resultant key C. Therefore, if an input key is “0011 1111”, the input key would match up with resultant key B, the only resultant key having a prefix matching the input key. However, if the input key is “0011 1000”, the input key would match with resultant key C. This is the case because although the input key matches with both resultant keys B and C, resultant key C has a longer prefix (8 bits) than resultant key B (4 bits).

The memory 142 may include a plurality of memory sections. In each of the memory sections, a plurality of resultant keys may be stored. All of the resultant keys may be stored in numerical ascending order, for example. In other embodiments, the resultant keys may be stored in descending order. The storage of the resultant keys in ascending (or descending) numerical order may result in faster search times to search for resultant keys. The value of the last (or first) resultant key of each memory section in the memory 142 may be stored in the pipelined binary search device 102. Accordingly, the pipelined binary search device 102 may be utilized to determine the section of the memory 142 in which to search for the resultant key having the longest prefix matching the input key. The value of a resultant key representing a memory section (e.g., memory section D) of the memory 142 may be stored in memory bank “1” 115.

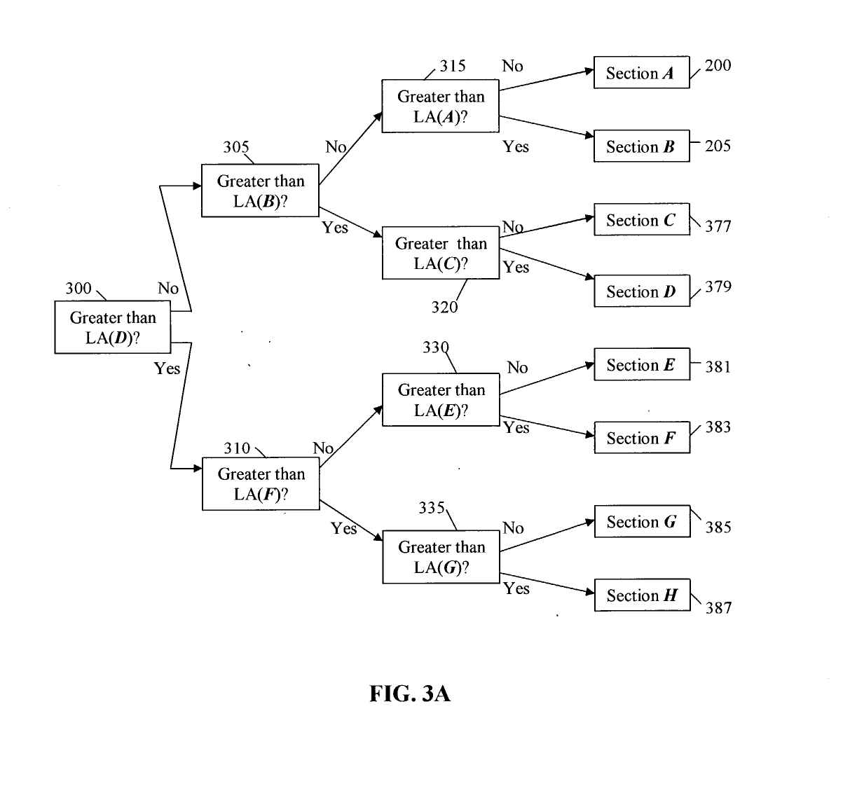

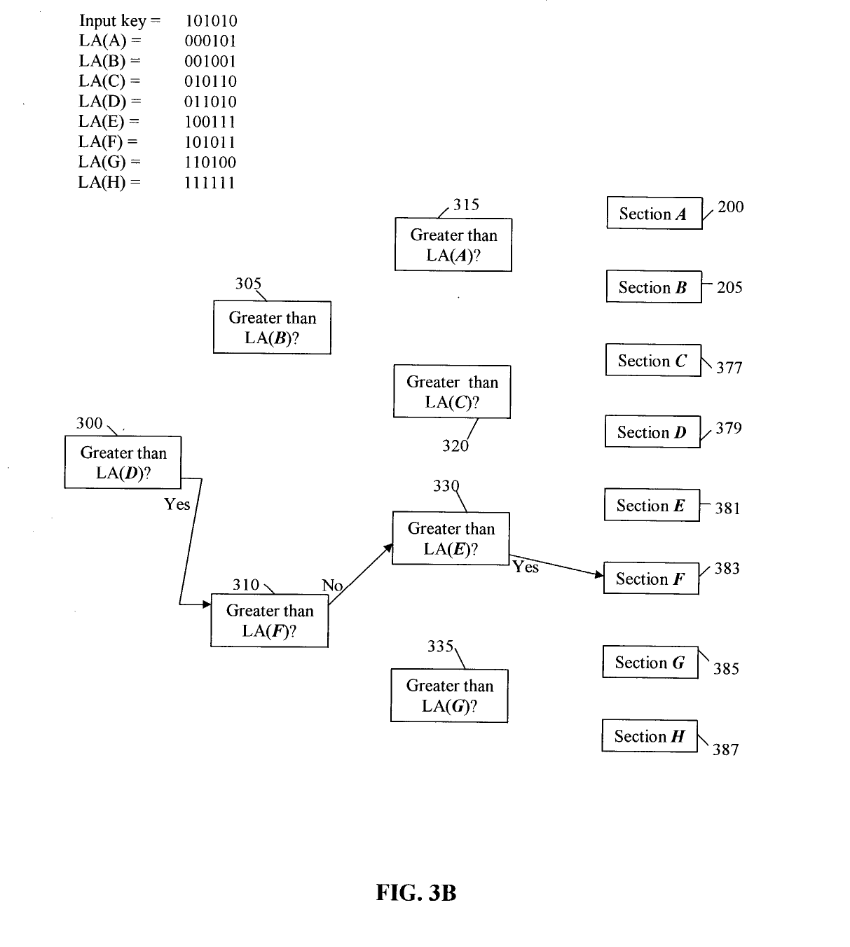

The last resultant key stored in memory section “D” may be stored in memory bank “1” 115, for example. In other embodiments, the first resultant key stored in memory section D may be stored in the memory bank “1” 115. Similarly, a value of a resultant key representing additional memory sections (e.g., memory sections B and F) of the memory 142 may be stored in memory bank “2” 120. The way in which the memory section address are selected for each memory bank is explained below with respect to FIGS. 3A and 3B. The values of the rest of the resultant keys representing other memory sections of the memory 142 may also be stored in similar memory banks of the pipelined binary search device 102, up to memory bank “X” 125, which may store the value of a resultant key representing memory section N of the memory 142.

If the last resultant keys stored in each of the sections of the memory 142 are stored in each of the memory banks “1” 115, “2” 120, and so on, up to “X” 125, those resultant key values may be searched to determine a section of the memory 142 in which a matching resultant key, if it even exists, may be located.

The system according to an embodiment of the invention may be optimized for hardware. Entries may be physically sorted, avoiding the need for pointers. Entries may be laid out in different sections so that the search can be pipelined. The pipelined binary search may need only one entry per section, which is a much lower amount of memory than the total table (making it suitable to be stored in a chip's internal memory). Therefore, only one access is required to the address look-up table containing all of the resultant keys. This may result in good usage of the bandwidth to the external memory, resulting in higher search rates for the same memory subsystem bandwidth.

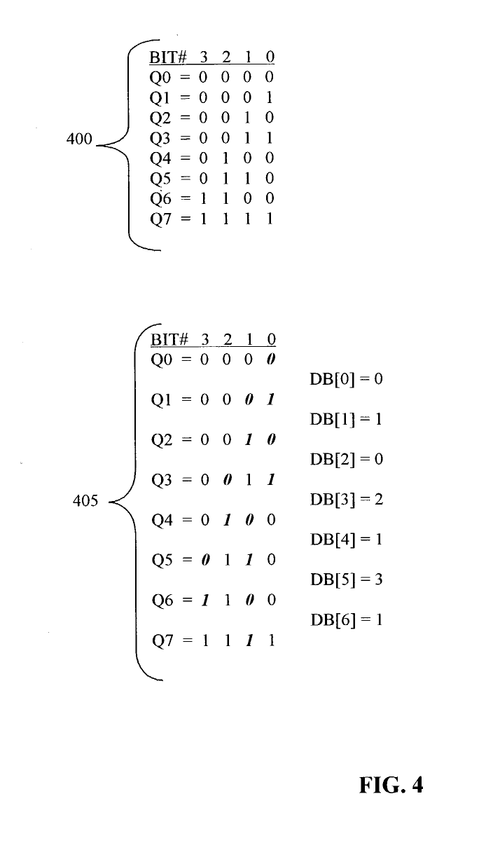

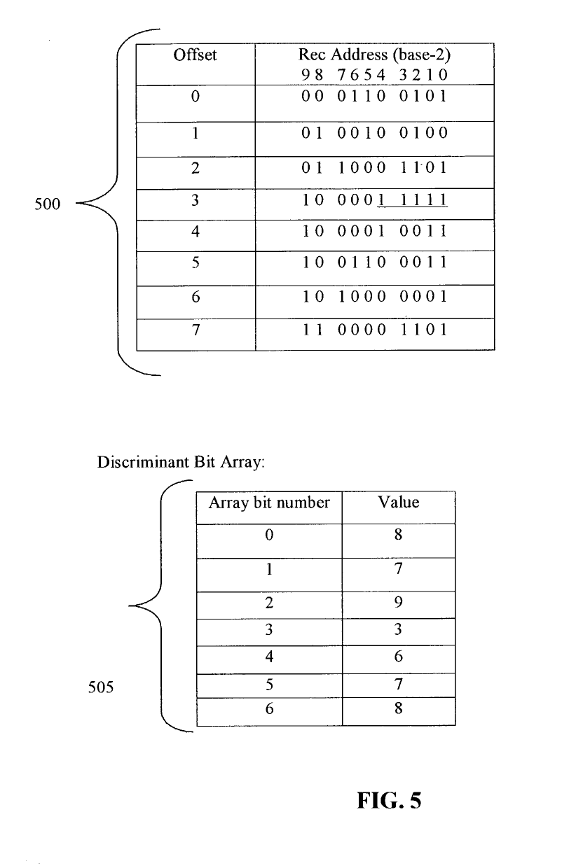

After the memory section of the memory 142 in which to search has been determined, a DB/LPM search module 130 may be utilized to locate the resultant key having the longest key matching that of the input key (if any such resultant key has a prefix matching the input key). A DP/LPM memory 135 may be utilized to hold a DB array for each of the memory sections of the memory 142. Each resultant key may include a DB associated with the resultant key. The DB may be the most significant bit number of a resultant key that differs from the previous resultant key, as explained in further detail below with respect to FIGS. 4 and 5. The DB/LPM memory 135 may also be utilized to store LPM rules for the resultant keys in the memory 142. The LPM rules may contain forwarding information for the resultant keys stored in the memory 142, as explained below with respect to FIGS. 7A and 7B. Once a resultant key having the longest matching prefix, or a default key if no resultant key has a matching prefix, has been determined, it may be sent to match device 188, which may utilize the located resultant key to determine the next hop information for the packet via reference to the address look-up table 145.

If the resultant key having the longest prefix is located, then a next hop value associated with the resultant key is determined from the address look-up table 145. If none of the resultant keys have prefixes matching the input key, a default key value may be provided by the memory 142. The default key value may then be matched to a next hop value via the address look-up table 145. Once the next hop address has been determined by the address look-up device 100, the next hop address may be sent to the forwarding device 140. The forwarding device 140 may then forward the packet to the next hop address. The address look-up device 100 may then process the next received packet and forward it to its next hop address. In an embodiment, match device 188 may be utilized to match the located resultant key of the memory 142 with the destination address of the packet in the address look-up table 145. In some embodiments, the match device 188 may be housed outside of the address look-up device 100. In other embodiments, the match device 188 may be housed inside of the address look-up device 100. In additional embodiments, the match device 188 may be located within the DB/LPM search device 105.

In an embodiment of the invention, the CPU 150 may control the pipelined binary search module 110 and the DB search module 130. In other embodiments, each of the pipelined binary search module 110 and the DB search module 130 may be controlled by separate processor devices, which may be different than CPU 150.

FIG. 1B illustrates a process to receive a packet, look up its next hop address, and forward the packet to the next hop address according to an embodiment of the invention. First, a packet is received 170. As discussed above, the packet may be received by the router 101. Next, an input key may be extracted 175 from the packet. A pipelined binary search may then be performed 180 to locate a section of the memory 142 in which to search for a resultant key having the longest prefix matching the input key. The address look-up device 100 may then perform 185 a DB/LPM search to locate the resultant key having the longest prefix matching the input key (if such a resultant key exists at all). Once a resultant key or a default key (if none of the resultant keys has a prefix matching that of the input key) has been determined, the corresponding next hop address may be determined 190 via an access to the address look-up table 145 of the memory 142. Finally, the packet is forwarded 195 by the forwarding device 140 to the next hop address.

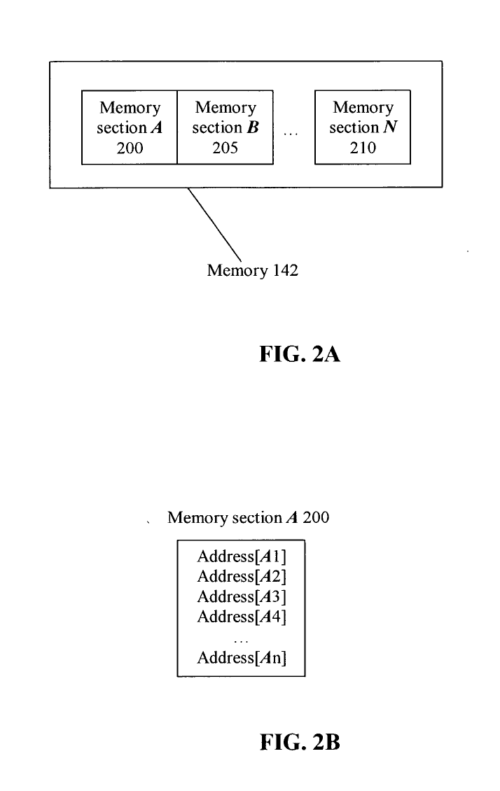

FIG. 2A illustrates a memory 142 according to an embodiment of the invention. As illustrated, the memory 142 may be broken into a plurality of memory sections. Each of the memory sections may be utilized to store an approximately equal number of resultant keys. The memory sections may include memory section A 200 (i.e., the first memory section), memory section B 205 (i.e., the second memory section), and so on, up to memory section N 210 (i.e., the Nth memory section).

FIG. 2B illustrates a memory section A 200 of memory 142 according to an embodiment of the invention. As shown, memory section A 200 may include a plurality of resultant keys, e.g., “Address[A1],” “Address[A2],” “Address[A3],” “Address[A4],” and so on, up to “Address[An].” Each of the resultant keys may be stored in ascending (or descending) order. Accordingly, Address[An] my be the last resultant key stored in memory section A 200. The value of Address[An] may be stored in one of the memory banks (115, 120, or 125). Similarly, the value of the last resultant key in memory section B 205 may also be stored in one of the memory banks (115, 120, or 125).

FIG. 3A, illustrates a method utilized to determine a section of the memory 142 in which to search for the resultant key having the longest prefix matching the input key. The method may be implemented by the pipelined binary search module 110. The method illustrated in FIG. 3A shows how the binary search is implemented on last address values (e.g., LA(A), LA(B), LA(C), LA(D), LA(E), LA(F), LA(G), and LA(H)) of “8” memory sections A 200, B 205, C 377, D 379, E 381, F 383, G 385, and H 387. The method described below illustrates the searching when the last resultant key of each memory section is stored in a memory section address in the pipelined binary search device 102. In other embodiments, the first resultant keys may be utilized instead of the last resultant keys.

The pipelined binary search may start in the middle of the set of last address memory sections. The binary search may be utilized to eliminate half of the potential last address memory sections at each stage of its search. First, the method may determine 300 whether the input key has a value greater than that of LA(D). If “yes,” processing proceeds to operation 310. If “no,” processing proceeds to operation 305. At operation 305, the method determines whether the input key is greater than the value of LA(B). If “no,” processing proceeds to operation 315. If “yes,” processing proceeds to operation 320. At operation 310, the pipelined binary search module 110 determines whether the input key has a value greater than LA(F). If “no,” processing proceeds to operation 330. If “yes,” processing proceeds to operation 335.

At operation 315, the system determines whether the input key has a value greater than LA(A). If “no,” then the resultant key having the longest prefix matching the input key is determined to fall within the memory section A 200 of the memory 142 (if it is located in the memory 142), and the system may perform a search within memory section A 200 of the memory 142. If “yes,” then memory section B 205 is selected. As explained below with respect to FIGS. 4-6, the DB/LPM search module 130 may search a selected section of the memory 142 for the corresponding resultant key. During the DB/LPM search, all of the resultant keys in the selected section of memory 142 may be searched, along with the last resultant key in a prior memory section. The only search in which the last address of the previous section is not included in the search is a search where the first memory section is selected, because there is no prior section of the memory 142 in which to search.

At operation 320, the system determines whether the input key is greater than LA(C). If “no,” memory section C 377 is selected. If “yes,” memory section D 379 is selected. At operation 330, the system determines whether the input key is greater than LA(E). If“no,” memory section E 381 is selected. If “yes,” memory section F 383 is selected. At operation 335, the system determines whether the input key is greater than LA(G). If“no,” memory section G 385 is selected. Is “yes,” memory section H 387 may be selected.

The method shown in FIG. 3A may also include an additional operation to handle the situation where the input key exactly matches every bit of the queried last address resultant key (e.g., LA(A), LA(B), etc.). An input key exactly matches a last address resultant key if all of their bits are identical. The method may include an additional operation to send an exactly matching resultant key to the DB/LPM search module 130 along with an instruction to indicate that a DB/LPM search need not be performed for the current input key. Instead, the address look-up device 100 need only match the destination address up for the resultant key, and the forwarding device 140 may route the input packet to the destination address.

The binary search is said to be “pipelined” because input keys are constantly being searched. After the first query is done on the key (i.e., 300 (comparing with LA(D))), the key is sent to the next query 305 or 310 and the subsequent key is subjected to the first query 300. It may take one cycle to make the first query, and another cycle to make the next query, and so on. A cycle is also known as a single lookup into the memory 142. Accordingly, the binary search is done so that while the third query (i.e., 315 (comparing with LA(A)), 320 (comparing with LA(C)), 330 (comparing with LA(E)), or 335 (comparing with LA(G))) is performed on an input key, the second query (i.e., 305 (comparing with LA(B)) or 310 (comparing with LA(F))) is performed on the subsequent key, and the first query (i.e., 300 (comparing with LA(D))) is performed on key received subsequent to the subsequent key. Accordingly, the pipelining is possible because of the different levels of the searching operation (e.g., when LA(D) is queried 300, LA(B) or LA(F) may also be queried 305 or 310, respectively).

To implement the pipelined binary search, LA(D) may be stored in memory bank “1” 115. LA(B) and LA(F) may be stored in memory bank “2” 120, and LA(A), LA(C), LA(E), and LA(G) may be stored in a memory bank “3”. Accordingly, the pipelined binary search may then be performed. First, an input key may be compared with the resultant key stored in memory bank “1” 115 (e.g., LA(D)). Next, the input key may be compared with one of the resultant keys stored in memory bank “2” (e.g., LA(B) or LA(F)), while the next input key is simultaneously compared with the resultant key stored in memory bank “1” 115, etc. Therefore, a new search may be performed during every cycle. In other words, after memory bank “1” 115 is queried, memory bank “2” 120 may be queried and memory bank “1” 115 may simultaneously be queried with a new input key, within the same cycle. Accordingly, a new search may be performed during every cycle, resulting in a high throughput.

FIG. 3B illustrates an implementation of a method utilized to determine a section of the memory 142 in which to search for the resultant key having the longest prefix matching the input key. As shown, the input key has a value “101010,” LA(A) is “000101,” LA(B) is “001001,” LA(C) is “010110,” LA(D) is “011010,” LA(E) is “100111,” LA(F) is “101011,” LA(G) is “110100,” and LA(H) is “111111.” The pipelined binary search device 102 may utilize the method of FIG. 3A to determine a memory section of the memory 142 in which to search for the resultant key.

First, the pipelined binary search device 102 determines 300 whether the input key (i.e., “101010”) is greater than LA(D) (i.e., “011010”). Since it is, the process next determines 310 whether the input key is greater than LA(F) (i.e., “101011”). Since the input key is less than LA(F), processing proceeds to operation 330 where the pipelined binary search device 102 determines whether the input key is greater than LA(E) (i.e., “100111”). Since it is greater, memory section F 383 is selected as the memory section of the memory 142 in which to search for a resultant key having the longest prefix matching the input key.

Once a memory section address has been selected, the section of the memory 142 having the selected memory section address, as well as the last memory address of the previous section of the memory 142, if it exists, may then be searched by the DB/LPM search device 105. As shown in FIG. 1A, the DB/LPM search device 105 may include a DB/LPM search module 130 and a DB/LPM memory 135. The DB/LPM memory 135 may be a Random Access Memory (RAM), for example. The DB/LPM memory 135 may be utilized to hold a DB array for each of the resultant keys in each memory section of the memory 142. The DB/LPM memory 135 may also be utilized to store the LPM rules for keys stored in the memory 142. The rules may contain forwarding information for the resultant keys.

A DB is the most significant bit of a resultant key that differs from the previous resultant key stored in the memory 142. FIG. 4 illustrates a table 400 of resultant keys stored in the memory 142 according to an embodiment of the invention. An expanded table 405 includes the resultant keys as well as the DBs for each of the resultant keys. As shown, resultant key Q0 has the value “0000,” and resultant key Q1 has the value “0001.” The value of the first DB, DB[0] is “0,” the most significant bit of Q1 that differs from the same numbered bit of Q0, the previous resultant key. Similarly, the second DB, DB[1] is “1,” the most significant bit of Q2 (“0010”) that differs from the respective bit of Q1. The rest of the DBs, DB[2]-DB[6] are determined in the same way. Accordingly, DB[0]-DB[6] form the DB array. The DB array may be determined by the DB search module 130, the CPU 150, or any other suitable processing device, and may then be stored in the DB/LPM memory 135.

Through the DB/LPM search device 105, the address look-up device 100 may utilize an LPM search to find a resultant key in the memory matching the input key of a received packet. LPM is a function that may be required by routers 101 to support Classless InterDomain Routing (CIDR). CIDR is an addressing scheme that employs supernet addresses to represent multiple Internet Protocol (IP) destinations. A supernet is a group of networks identified by contiguous network addresses. Rather than advertise a separate route for each destination in a supernet, a router 101 may use a supernet address to advertise a single route—called an aggregate route—that represents all of the destinations. This may reduce the size of routing tables used to store advertised IP routes.

The address look-up device 100 may be utilized to support 256K routing entries at 44 Gbps switching bandwidth, for example. Higher speeds may also be possible. This may result in a need to perform look-ups for 66 million packets/sec (assuming minimum packet size of 64 bytes).

If all resultant keys were represented as having no prefix, there may be ambiguities since different resultant keys may get represented by the same word. For example,

1010_{—}11XX→may be represented as 1010_{—}1111;

1010_{—}1XXX→may be represented as 1010_{—}1111; and

1010_XXXX→may be represented as 1010_{—}1111

Given the entry 1010_{—}1111 in the memory 142, the system cannot find out which one of the resultant keys is the key having the longest matching prefix. Therefore, to complete this information, the system includes the prefix length information for each resultant key. This information may be part of the resultant key, in order to avoid having repeated keys in the memory 142. Another requirement may be that if there are several words like the ones above, for a given query the system should match the most specific one. One way to achieve this is to encode the resultant keys of the memory 142 in the following way:

1010_{—}11XX→represented as {1010_{—}1111, 010}

1010_{—}1XXX→represented as {1010_{—}1111, 011}

1010_XXXX→represented as {1010_{—}1111, 100}

Accordingly, the resultant key has been appended with “mask Length” information, where “maskLength”=“keyLength”−“prefixLength”, where “maskLength” represents the length of the mask, “keyLength” represents the length of the key, and “prefixLength” represents the length of the prefix.

Now, if the system queries for {1010_{—}1111, 000}, the DB search may match from the {1010_{—}1111, *} entries the entry which has smallest maskLength (i.e., the most specific one) which is the reslutant key having the longest matching prefix. This is the case because the DB search may always choose the portion of the memory 142 in which the value of the DB is 0 (i.e., it is querying with all zeros on the maskLength field). This may point it to the smallest one in the memory 142.

The same effect may also be achieved by extending the key with the prefixLength itself (rather than maskLength) and the querying with {Key, 11..1}.

Accordingly, if the original resultant key was an IPv4 address (32 bits), 5 extra bits may be needed to encode the maskLength field (a range of 0-31, assuming a default entry is not allowed, which will be all x's, or 6 bits if 0-32 are supported). Therefore, the total length of the resultant key would be 37-38 bits.

A DB search may therefore be utilized to locate an entry, or potential entries in which a resultant key having a prefix matching that of the input key may be located. FIG. 5 illustrates an additional key table 500 and a DB array 505 according to an embodiment of the invention. As shown, each of the resultant keys is formed of “10” bits. The column heading entitled “offset” refers to the resultant key number of the searching area. As shown, resultant keys “0,” “1,” “2,” “4,” “5,” “6,” and “7” all have a prefix that is “10” bits long, the length of the resultant key. Resultant key “3,” however, has a prefix that is “5” bits long. The last “5” bits of key “3” are represented by “5” underlined “1” characters. Each underlined “1” character represents a bit whose value does not matter to the DB/LPM search device 105. Each underlined “1” character may also be known as a “don't care” bit. In practice, each of these “don't care” bits may be stored as a “1” along with information indicating that the value of the bit does not matter.

A DB array 505 is also shown. As described above with respect to FIG. 4, a DB of a key is the most significant bit of the key that differs from the respective bit of the previous key. Accordingly, first DB (i.e., DB “0”) is “8,” because the most significant bit of key “1” that differs from that of key “0” is the eighth bit. DBs “1”-“2” are also determined in a similar manner.

Accordingly, the DB array 505 is determined to be {8, 7, 9, 3, 6, 7, and 8}. If the input key has a value “10 0001 0010,” the resultant key having the longest prefix matching the input key may be determined by first determining the value of the most significant bit of the key that is represented by the DB array. Here, the largest DB is “9.” DB “2” has the value “9” because it is the most significant bit of key “3” that differs from key “2.” Since the resultant keys are stored in numerical order in the memory, every DB will represent the most significant bit of a key that is “1” in the key, but “0” in the previous key. As shown, bit “9” of key “3” is “1,” but bit “9” of key “2” is “0.”

Since “9” is the value of the largest value of the DB array, bit “9” of the input key is determined. Bit “9” of the input key “10 0001 0010” is “1.” Accordingly, it is determined that a matching resultant key must be located in the portion of the key table having keys “3”-“7.” Next, the next most significant DB of the portion of the table having keys “3”-“7” is determined. The next largest DB is DB “6,” which has the value “8.” Accordingly, bit “8” of the input key is determined. Since bit “8” of the input key is “0,” all keys (i.e., key “7”) below the key associated with DB “6” are now excluded from an additional search. Accordingly, the search continues on keys “3”-“6.”

The next largest DB of the remaining keys is “7,” which is DB “5.” Accordingly, the value of bit “7” of the input key is determined. Since bit “7” of the input key is “0,” key “6” may be eliminated, leaving bits “3”-“5” still to be searched. Next, the value of the next most significant remaining bit is determined to be “6.” Since bit “6” of the input key is “0,” key “5” may be eliminated, leaving only keys “3” and “4” left to be searched. Accordingly, bits “9 ,” “8,” “7,” and “6” of keys “3” and “4” are now known to be identical to that of the input key.

Key “3” has a prefix that is “5” bits long (i.e., the first “5” bits of key “3” matter, and the last “5” bits are “don't care” bits). Key “4” has a prefix that is “10” bits long, which is equal to the length of key “4.” Both key “3” and key “4” have the same first “5” bits (i.e., the “5” most significant bits). These common bits are “10 000.” Accordingly, the entire prefix of key “3” is identical to the first “5” bits of key “4.” Therefore, key “3” is said to be a prefix of key “4,” and key “4” is therefore nested to key “3.” Thus, any input key having the first “5” bits that are “10 000” will match key “3,” regardless of what the last “5” bits are. In an LPM search, the resultant key having the longest prefix matching the input key is matched with the input key. Accordingly, resultant key “3” may be selected as the longest prefix match resultant key for all input keys beginning with “10 000” except for an input key matching key “4,” “10 0001 0010.” This is the case because although an input key having a value “10 0001 0010” matches the prefix of both keys “3” and “4,” the prefix of key “4” is longer. By definition, an LPM search matches the resultant key having the longest prefix matching that of the input key.

Returning to the example shown in FIG. 5, only keys “3” and “4” remain after having bits “9,” “8,” “7,” and “6” compared with those of the input key. The system may then compare the remaining bits to determine which key, if either of them, has the longest prefix matching that of the input key. Key “3” may have data associated therewith indicating that its prefix is “5” bits long. The only one of key 3's prefix bits (i.e., its “5” most significant bits) that has not yet been compared is bit “5.” Since DB “3” of the DB array 505 has the value of “3,” i.e., the most significant bit of key “4” that differs from that of key “3,” the system may determine that bit “5” of both keys “3” and “4” must be identical. Accordingly, the system may then compare bit “5” of key “4” (bit “5” of key “3” could also have been compared; it does not matter because keys “3” and “4” have the identical bit “5”) with bit “5” of the input key. Since the input key and resultant keys “3” and “4” all have a bit “5” that is “0,” the system determines that the first “5” bits of both keys “3” and “4” match that of the input key. Accordingly, the system then determines that the prefix of key “3” matches that of the input key. When two or more resultant keys have prefixes matching that of the input key, the DB/LPM search device 105 will match at least one of them with the input key. In a situation where hundreds, or thousands of resultant keys are stored in the search memory section, all of the bits of a prefix may automatically be compared pursuant to the DB search without separated testing as shown above with respect to bit “5.”

The rest of the bits of key “3” and “4” must then be compared with that of the input key to determine the matching resultant key. Since the last “5” bits of key “3” are all “don't care” bits, dummy entries may be created to force a comparison between key “3” and key “4.” Dummy entries are necessary to force each bit of the input key to be compared with a corresponding bit of a resultant key in the memory 142. Since the entire prefix (i.e., the “5” most significant bits of resultant key “3”) match with the input key, one of resultant keys “3” and “4” is guaranteed to match the input key. However, key “4” may only match the input key if all “10” of its bits are identical to those of the input key. Accordingly, a bit-by-bit comparison between resultant key “4” and the dummy keys representing resultant key “3” may be necessary.

Key “4” has the following last “5” bits: “1 0011.” Accordingly, dummy entries having the same first “5” bits as key “3” may be created. The last “5” bits of each respective dummy entries may then successively differ from key “4” by one bit. The first dummy entry may be “10 000” (i.e., the actual first “5” bits of key “3”) followed by “0 1111.” Accordingly, the input key “10 0001 0010” is then compared against key “4,” “10 0001 0010” and dummy key #1 “10 0000 1111.” Since bit “4” of the input key is “1,” which matches bit “4” of key “4,” but not bit “4” (i.e., “0”) of dummy key #1, dummy key #1 may then be eliminated.

Dummy key #1 is therefore used to make the following comparison:

| | |
|---|---|
| Input key = | 10 0001 0010 |
| Key “4” = | 10 0001 0011 |
| Dummy key #1 = | 10 0000 1111 |

Since bit “4” of key “4” matches that of the input key, bit “3” of key “4” must then be compared with that of the input key. If, however, bit “4” of key “4” had not matched bit “4” of the input key, the DB search would have eliminated resultant key “4,” and a dummy key representing resultant key “3” would have been determined to be the key having the longest prefix matching that of the input key. Since it was not, bit “3” of key “4” must then be compared to that of key “4.” Accordingly, a dummy entry may then be created to force this comparison.

Dummy key #2 is then compared, and the following comparison is made:

| | |
|---|---|
| Input key = | 10 0001 0010 |
| Key “4” = | 10 0001 0011 |
| Dummy key #2 = | 10 0001 1111 |

Since bit “3” of key “4,” but not bit “3” of dummy key #2 is identical to bit “3” of the input key, dummy key #2 is eliminated. The remaining bits of key “4” are then compared with the input key until (a) it is determined that all bits of key “4” match those of the input key, or (b) a bit of key “4” does not match that of the input key, and key “3” is the resultant key having the longest prefix matching that of the input key.

The following comparisons are then made:

| | |
|---|---|
| Input key = | 10 0001 0010 |
| Key “4” = | 10 0001 0011 |
| Dummy key #3 = | 10 0001 0111 |

| | |
|---|---|
| Input key = | 10 0001 0010 |
| Key “4” = | 10 0001 0011 |
| Dummy key #4 = | 10 0001 0101 |
| Input key = | 10 0001 0010 |
| Key “4” = | 10 0001 0011 |
| Dummy key #5 = | 10 0001 0110 |

The system finally determines that bit “0” of key “4,” does not match bit “0” of the input key, but that instead bit “0” of dummy key #5 matches that of the input key. Accordingly, dummy key #5 would be selected. The system may then determine that dummy key #5 is a derivative key made from key “3.” The system then determines that key “3” is the key having the longest prefix matching that of the input key. The DB search module 130 may then match up resultant key “3” with a destination address stored in address look-up table 145. The packet may then be sent to the destination address via forwarding device 140.

The DB search module 130 may provide a method of comparing resultant keys that results in a decrease of the number of dummy keys utilized. A way to reduce the number of dummy keys is to store a pointer to forwarding rules of a resultant key “nested” to another resultant key. The forwarding rules may be stored in memory 142. A nested key is a key that has a set of bits that are equivalent to that of the prefix of another key. In the set of resultant keys shown in the key table 500 of FIG. 5, key “4” is nested to key “3.” This is because key “3” has a prefix that is “5” bits long, and those “5” bits are identical to the first “5” bits of resultant key “4.”

Accordingly, a pointer to certain rules may be stored for a nested resultant key. This may take care of resultant keys nested into a resultant key for a nesting level without the need for any dummy entry. The rules may include: (1) the key prefix length; (2) the nesting prefix length; and (3) a pointer to nesting information.

Accordingly, in the situation above where key “3” was “10 0001 1111” and key “4” was “10 00001 0011,” after the first “5” bits have been compared to those of the input key, key “4”may be directly compared without referring to key “3.” This may be implemented by creating a pointer for key “4” which indicates that it is nested to key “3.” Accordingly, the system may perform a bit-by-bit comparison directly between key “4” and the input key to determine whether the last “5” bits of key “4” and the input key match. If key “4” exactly matches the input key (i.e., all of the bits are the same) then key “4” would be selected as the resultant key having the longest prefix matching the input key. However, if any of the last “5” bits of key “4” do not match the input key, then the system may determine that key “3” is the resultant key having the longest matching prefix, based on the information pointed to by the pointer to key “3.”

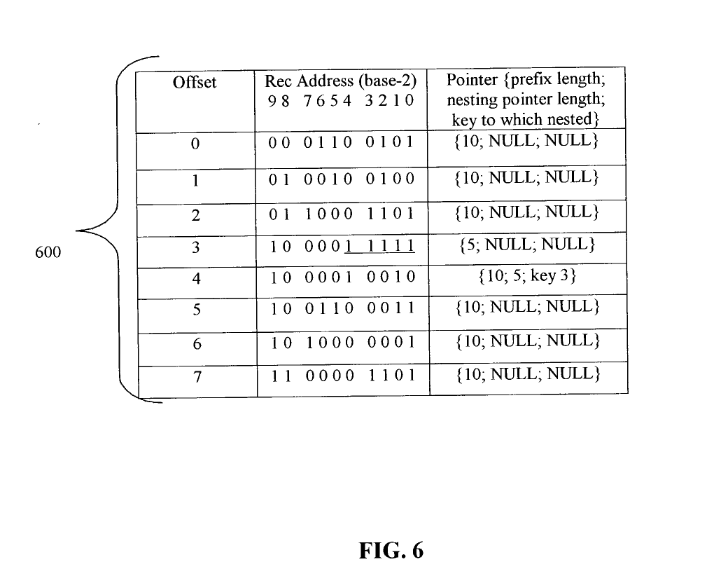

FIG. 6 illustrates a resultant key and pointer table 600 according to an embodiment of the invention. As shown, each resultant key has a pointer associated therewith. The pointer may point to information concerning (a) the prefix length; (b) the nesting prefix length; and (c) the key to which the key is nested. In other embodiments, other information may be pointed to by the pointers. Resultant key “0” has a pointer to the following information: {10; NULL; NULL}. This information indicates that resultant key “0” has a prefix that is “10” bits long, and the NULLs indicate that there is no information concerning the nesting prefix length and the key to which the queried key is nested. The NULLs are therefore present because key “0” is not nested to another key. Similar information is stored in pointers to resultant keys “1,” “2,” “5,” “6,” and “7.” Resultant key “3,” however, has the following information in its pointer: “5,” which indicates that its prefix is the first “5” bits. Resultant key “4” has the following information stored with its pointer: “10,” which is the prefix length; “5” which is the value of the nesting prefix length (i.e., the “5” bits after the common “5” bits shared with resultant key “3”); and “key ‘3’” which is the resultant key to which resultant key “4” is nested.

Key “3,” which has the value “10 0001 1111,” may be stored in the memory as “10 0001 1111,” along with the prefix length value “5” in its associated pointer. The prefix length value is utilized to indicate which of the bits of the key form the prefix. Since the prefix length value is “5,” the system may disregard the last “5” bits of key “3.”

The DB/LPM search device 105 may also be programmed to deal with a situation where resultant keys have more than one nesting level. For example, if the following keys are in a table:

| | |
|---|---|
| Key: | Value |

| | | | |
|---|---|---|---|
| #1 | P0 | P1 | A |
| #2 | P0 | P1 | B |
| #3 | P0 | P1 | — |
| #4 | P0 | — | — |
| #5 | P3 | — | — |
| #6 | P4 | — | — |

“P0,” “P1,” “P2,” “P3,” “P4,” “A,” and “B” may each represent chunks of bits of a set length (e.g., a 4-bit number). Each “-” represents a chunk of “don't care” bits. As shown, keys #1 and #2 are nested into key #3. Key #3 is nested into key #4. If the input key being queried is “P0 P1 X,” and X does not equal A or B, then pursuant to the DB search, one of keys #1, #2, or #3 is guaranteed to match the input key because the input key has the prefix “P0 P1.” (As between key #1 and key #2, the DB search is utilized to eliminate one of keys #1 and #2. Then the remaining key may be queried.) If key #1 is first queried, the search may determine that key #1 does not match the input key. The system may access the record for key #1 and after determining that key #1 does not match, the system may return key #3 as the matching resultant key. Specifically, a pointer associated with key #1 may point to key #3, and key #3 may then be returned as the longest matching prefix. The same result may occur if key #2 had been queried. Since key #2 does not exactly match the input key, the system may return key #3 as the longest matching prefix after accessing the pointer for key #2.

However, if the input key were “P0 X Y,” where X does not equal “P1,” then the system has to deal with two nested key levels. If either key #1 or key #2 is initially queried, and neither matches the input key, the information for key #3 would be returned. Key #3 would then be queried, and its pointer to the rules for key #4 would be acquired and returned. Accordingly, performance may degrade if there are many nesting levels (for 32-bit IP addresses there are up to 31 nesting levels) as the number of memory accesses to get the result of the query increases. Accordingly, the system is configurable to return key #4 right away without resorting to key #3. A way to do this is, when entry “D” is inserted into the memory section of the memory 142 as key #4, to detect that key #4 is nested “2” levels, and add dummy entries to ensure that “A” or “B” will be matched only if “P1” has been fully compared (similarly if A or B are inserted and are detected to be nested “2” levels). To do this, dummy entries may be inserted to ensure that P1 gets fully compared. Therefore, in the worst case scenario, as many dummy entries as the number of bits forming chunk “P1” must be compared. Statistically, the addition of the dummy entries generally adds only 3% overhead to the memory for routing databases of size 25 k and larger. In other words, in a typical scenario, only 3% additional dummy entries need be added to the memory 142.

As the number of nesting levels increases, more dummy entries are required. One way to reduce the number of dummy entries required is to provide pointers to the information associated with rules of keys nested more than “1” level up.

When nested resultant keys are included in a table in the memory 142, various rules may be associated with each of the respective resultant keys, in order to allow an address look-up to quickly occur. The “rules” may,be the information pointed to be the pointer for each of the resultant keys. Each time a resultant key is added to a table of keys in a memory section of the memory 142, the rules for each of the added resultant key may be determined and added to a pointer associated with the added resultant key in the memory 142.

For example, if the following resultant keys are stored in a table in a memory section of the memory 142, various forwarding rules for the resultant keys may be determined:

| | |
|---|---|
| Key | Value |

| | | | | | |
|---|---|---|---|---|---|
| AA | P0 | P1 | P2 | A | — |
| BB | P0 | P1 | P2 | B | — |
| CC | P0 | P1 | P2 | — | — |
| DD | P0 | P1 | — | — | — |

In the above table, “P0,” “P1,” “P2,” “A,” and “B” may all be groups of bits comprising each of the keys “AA,” “BB,” “CC,” and “DD.” Each “-” represents “don't care” bits of the key. Key “AA” may have rules in its pointer indicating that it is nested one level to key “CC” and two levels to key “DD.” Key “BB” may also have rules in its pointer indicating that it is nested one level to key “CC” and two levels to key “DD.” Since keys “AA” and “BB” are each nested two levels, dummy keys may be added to the table to ensure that key “AA” or key “BB” will only be matched after the “P2” chunk of bits have been fully compared. The dummy key entries are therefore utilized to ensure that “P2” is fully compared. If any of the “P2” bits do not match the input key, then keys “AA,” “BB,” and “CC” may be excluded because they do not match those of the input key.

If another key “EE” having the value “P0 P1 P2 A Q” is added to the table, then information may be added to the rules pointed to by the pointer for key “EE” indicating that it is nested one level to key “AA,” two levels to key “CC,” and three levels to key “DD.” Dummy entries may also be added to the table of resultant keys to ensure that the “P2” bits are fully compared before key “EE” is matched.

Each time a new resultant key is to be added to the table of resultant keys in the memory 142, the rules associated therewith may be added for a pointer associated with the resultant key. For example, when a new resultant key and associated rules are to be added, the system may first determine whether an identical key and rules associated therewith are already present in the memory 142. If already present, the rules for the added resultant key are written over the already existing rules for the identical key. However, if the resultant key and rules associated therewith are not already present in the memory, the system may determine whether the resultant key and rules associated therewith are nested to or nest already existing keys and rules associated therewith.

If the resultant key and rules associated therewith are nested to at least two levels of rules and nest no other keys, then dummy entries may be added to the table to ensure that the system compares the first nesting level to which is nested. For example, if in a new table the keys “GG”=“P0 P1-” and “HH”=“P0--”, if the key “II”=“P0 P1 X” is added, the dummy entries may be added to ensure that the bits in the “P1” chunk are compared.

If the added resultant key nests one resultant key and has at least one resultant key nested to itself, dummy entries may be added to ensure that the bits in the prefix of the added resultant key are fully compared with that of the resultant key it nests. Pointers point to rules rather than to resultant keys because of the dynamic nature of a resultant keys table in a memory section of the memory 142, in which every insertion may end up moving keys up and down (as they are “physically” sorted). Therefore, to manage pointers to keys would be much more complex (they could move on every insertion) than to manage pointers to rules. In fact there is nothing in the parent key that is needed, only the rule for the parent key is needed, so to access it would be a waste of bandwidth (the system would end up accessing 2 keys and 1 rule instead of 1 key and 1 rule). Accordingly, pointers to rules for resultant keys are used for bandwidth purposes and simplicity of management. For example, if keys “HH”=“P0--” and key “II”=“P0 P1 X” are already in the memory 142, and key “JJ”=“P0 P1-” is added, dummy entries may be added to ensure that the bits of chunk “P1” are fully compared.

Another potential situation is where a resultant key is added that nests at least two levels of other resultant keys. For example, if keys “II”=“P0 P1 X” and “JJ”=“P0 P1-” are in the memory 142 and key “KK”=“P0--” is added, new dummy entries must be added to the memory 142. This is because new key “KK” nests key “II” to two levels and “JJ” to one level. Accordingly, dummy entries may be added to ensure that the bits in “P1” are fully compared.

According to the DB/LPM search, the following property [DB/LPM PROPERTY] is true:

given a table in the memory 142 of resultant keys T={K0..Kn−1}, n>0, where each entry contains a pointer to the information associated to the resultant key (if any) to which it is nested, if

(a) Ki<=X<=Kj, where i<j, then

(b) The discriminant bits search for X in sub-table S={Ki, . . . ,Kj} (denoted as DBS(S,X)) may point to the resultant key having the longest matching prefix of X in T (denoted as LPM(T,X))

X may be a key having the form {x y z}, where x, y and z are chunks that together form key X, and M={x y -} (“-” represents “don't care bits”) is the longest prefix matching entry of X in T. Accordingly, M=LPM(T,X).

Proof of DB/LPM Property

The DB/LPM PROPERTY equation may be proven for several mutually exclusive cases, which cover all possible solution space.

Case 1: Ki<=M<=Kj

In this case M=LPM(T,X) is in sub-table S. If M={x y-}, where “-” represents “don't care bits”, and M is the only entry of this type in S, the DB search will match it. If there are several entries M={x y z0}, . . . , Mn={x y zn} then DBS will match one of them, e.g., Mi. All {M0, M1, . . . , Mn} contain a pointer to M so after comparing X with Mi, DBS may return the correct result (e.g., the information for key M).

Case 2: Kj<M

In this case the matching entry is outside S. Accordingly, the DB search of (S,X) points to the information for key M. There is at least one entry in S which shares X prefix (e.g., {x y-}) which property 1 ensures will get matched by X and will give access to (e.g., the information for key M).

By hypothesis, X<=Kj<M. This transforms this into:

{x y z}<=Kj<{x y zm}

Therefore, this implies Kj={x y zj} for some zj (with z<=zj<zm)

So there is at least one entry in S that has a common prefix with X, and this is Kj. This ensures that at least that one will be the resulting of applying DBS over S and that one will point to the information for key M. Any other match of the type {x y -}, if existent in S, may also point to the information for key M.

Case 3: M<Ki

By hypothesis, case 3 may transform into M<Ki<=X

If the rules are represented so that anything after the prefix (i.e., the “don't care” bits) become ones, then this case is not possible (e.g., 127.5.3.- becomes 127.5.3.255) as for any X which has as LPM match M, following is true: X<=M. Accordingly, this case would not be possible.

The implications of this property is that if the pipelined binary search is performed to narrow down the search to a section of the memory 142, the DB search may be utilized to find the resultant key having the longest matching prefix if the DB search includes the entries that range from LastAddress(n−1) to LastAddress(n) are both included.

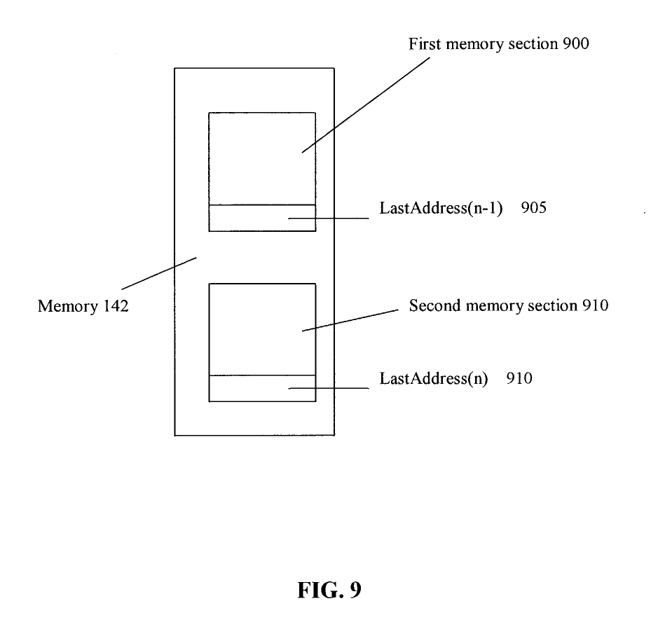

FIG. 9 illustrates two memory sections of the memory 142 according to an embodiment of the invention. The first memory section 900 includes a LastAddress(n−1) 905. The second memory section 910 includes a LastAddress(n) 915. When the pipelined binary search narrows the search down to the second memory section 910, the DB search space must include the last address (i.e., LastAddress(n−1) 905) of the first memory section 900.

FIG. 7A illustrates a first portion of a method to determine and add dummy entries for nested keys to the memory 142 storing the resultant keys according to an embodiment of the invention. First, the system determines 700 whether an added key “R” and its associated rules nest any other resultant keys and rules in the memory 142. If “yes,” processing proceeds to operation 705. If “no,” processing proceeds to operation 710, where the system determines whether the added resultant key matches 710 a resultant key already in the memory 142. If “yes,” the matching resultant key and rules are overwritten with the identical resultant key and rules. If “no,” the resultant key R and rule are added 725 to the memory 142. After operations 720 and 725 are performed, processing may continue at operation 745.

At operation 705, the new resultant key and the rules associates therewith are added to the memory 142. At operation 715, the system determines whether resultant key R, and the rules associated therewith, nest another resultant key and associated rules. If “yes,” dummy entries are added 730 to the memory 142 to test the first nesting level to which the resultant key and associated rules are nested, and processing proceeds to operation 735. If the answer at operation 715 is determined to be “no,” processing proceeds to operation 745.

The system then determines whether key R and its associated rules are nested 735 to at least “2” other resultant keys. If “yes,” additional dummy entries may be added 740 to the memory 142 to test the nesting level one below that of the key R, and processing proceeds to operation 745. If “no,” processing proceeds directly to operation 745.

FIG. 7B illustrates a second portion of a method to determine and add dummy entries for nested keys, and the rules associated therewith, to the memory 142 storing the resultant keys according to an embodiment of the invention. First, the system determines 745 the first resultant key, and the rules associated therewith, nested to key R and its associated rules. For example, the first nested resultant key may be referred to as “Ri.” Next, the system makes 750 the nested information pointer “Nested InfoPointer” of Ri point to R.info, which is the forwarding and nesting information for key R. “Nested InfoPointer” may contain forwarding rules of the nested entry. Next, the system determines 755 whether there is a LPM rule for the entry Ri. A LPM rule may exist if Ri nests other keys and associated rules. If “Yes,” the lowest entry nested to Ri is determined 760. If “no,” processing proceeds to operation 780. The lowest nested entry is determined at operation 760 so that the system can loop across all entries nested to a given one. This is because “1's” for the “don't care” bits beyond the prefix. If the “1's” are replaced with “0's,” that may provide the entire range of entries covered by the LPM search (e.g., 1010xxx is represents the range 1010000-1010111). This is used to skip a whole range of LPM's and keep proceeding over the entries at the same nesting level.

After operation 765, the system adds 770 dummy entries for the nesting level between the added key R and nested key Ri. Next, the system skips 775 to the lowest entry nested to Ri. Next, “i” is incremented 780. The system then determines 785 whether another key is nested to key R. If yes, this key is Ri, and processing returns to operation 745. If no, the processing ends and the memory table update is complete. The CPU 150 may be utilized to update the table in the memory 142.

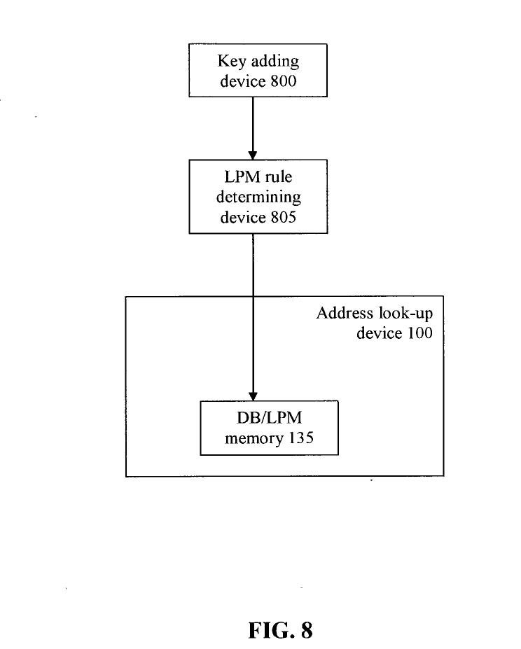

FIG. 8 illustrates a rule-adding device to add LPM rules to a DB/LPM memory 135 according to an embodiment of the invention. A key adding device 800 may receive a resultant key that is to be added to the memory 142. The resultant key may be sent to an LPM rule determining device 805, which may implement the method shown in FIGS. 7A and 7B to determine the nesting rules for the added resultant key. The LPM rules may then be stored in the DB/LPM memory 135.

According to an embodiment of the invention, a packet having a key or address associated therewith may be received. An address look-up device 100 may be utilized to determine the destination address for the packet based on the input key. A pipelined binary search device 102 may be utilized to determine a section in a key memory 142 in which to search for a key having the longest prefix matching that of the input key. The key memory 142 may store keys in a numerical order. After the appropriate section of the memory 142 is determined, a DB/LPM search device 105 may perform a discriminant bits search based on comparing bits of the input key with the most significant bits of the keys stored in the memory 142 that differ from the previously stored key. After a key having the longest prefix is determined, or a default key if no matching keys are located in the memory 142, the located key is then matched with a destination address via reference to a address look-up table 145.

An LPM search may be utilized to determine the matching key in the memory 142. Once a DB search is completed, an LPM search may be performed to determine the matching key. Each key may having a pointer associated therewith, the pointer indicating the prefix length, the length of the prefix of a key to which the key is nested, as well as the name of the nesting key, if there is one. The system may also provide a method for determining when dummy entries must be added to perform the longest prefix match search on keys having more than one nesting level.

While the description above refers to particular embodiments of the present invention, it will be understood that many modifications may be made without departing from the spirit thereof. The accompanying claims are intended to cover such modifications as would fall within the true scope and spirit of an embodiment the present invention. The presently disclosed embodiments are therefore to be considered in all respects as illustrative and not restrictive, the scope of an embodiment of the invention being indicated by the appended claims, rather than the foregoing description, and all changes which come within the meaning and range of equivalency of the claims are therefore intended to be embraced therein.

What is claimed is:

1. A system, comprising:
a search device to receive an input key and determine a memory reference identifying one of at least one memory section of a memory device in which to search for a resultant key having a longest prefix matching the input key; and
a Discriminant Bits (DB)/Longest Prefix Match (LPM) search device to receive the input key and the memory reference, and to utilize a DB pattern and a set of LPM rules to determine and provide a determined key.

2. The system according to claim 1, wherein the determined key is selected from the group consisting of: (a) the resultant key having the longest prefix matching the input key if located in the memory device, and (b) a default key if the resultant key having the longest prefix matching the input key is not located in the memory device.

3. The system according to claim 2, wherein the memory device contains a address look-up table to store a next hop address for each of the resultant key and the default key.

4. The system according to claim 3, further including a match device to match the determined key with the next hop address in the address look-up table.

5. The system according to claim 1, wherein the search device performs a pipelined binary search to search a plurality of memory banks to determine the memory reference.

6. The system according to claim 5, further including a processor to determine the at least one memory section of the memory device and place an address from each of the at least one memory section into each one of the memory banks.

7. The system according to claim 1, wherein the LPM rules include forwarding information for forwarding a packet.

8. The system according to claim 1, wherein the at least one memory section is utilized to store a plurality of resultant keys and associated next hop addresses.

9. The system according to claim 1, further including a forwarding device to forward the packet to a next hop address based on the determined key.

10. The system according to claim 1, further including a key extraction device to extract the input key from the packet and provide the input key to the search device.

11. The system according to claim 1, wherein the memory device contains a address look-up table to store next hop addresses for each of the plurality of resultant keys and the default key.

12. The device according to claim 1, wherein the DB/LPM search device includes a DB/LPM module to determine the DB pattern from keys stored in the memory device.

13. The device according to claim 1, wherein the DB/LPM search device includes a DB/LPM memory to store the DB pattern and the set of LPM rules.

14. The system according to claim 1, wherein the DB/LPM search device includes a DB/LPM memory to store the set of LPM rules.

15. The system according to claim 1, further including an LPM rule determining device to add a new resultant key to the memory device and add dummy keys to a set of the LPM rules, if the new resultant key nests any of the old resultant keys and the new resultant key is nested by any of the old resultant keys, and
update the LPM rules of all of the old resultant keys nested to the new resultant key.

16. A method, comprising:
receiving an input key;
performing a search to identify one of at least one section of a memory device in which to search for a resultant key having a longest prefix matching the input key and provide a memory reference; and
performing a Discriminant Bits (DB)/Longest Prefix Match (LPM) search based on the input key and the memory reference, and utilizing a DB pattern and a set of LPM rules to determine and provide a determined key.

17. The method according to claim 16, wherein the determined key is selected from the group consisting of: (a) the resultant key having the longest prefix matching the input key if located in the memory device, and (b) a default key if the resultant key having the longest prefix matching the input key is not located in the memory device.

18. The method according to claim 16, wherein the search is a pipelined binary search of a set of memory banks.

19. The method according to claim 18, further including determining the at least one section of the memory device and placing an address from each of the at least one section into the memory banks.

20. The method according to claim 16, further including determining a next hop address by matching the determined key with a set of next hop addresses in a address look-up table.

21. The method according to claim 20, further including forwarding the packet to the next hop address.

22. The method according to claim 16, wherein the DB/LPM search device includes a DB/LPM module to determine the DB pattern from keys stored in the memory device.

23. The method according to claim 16, wherein the DB/LPM search device includes a DB/LPM memory to store the DB pattern.

24. The method according to claim 16, wherein the DB/LPM search device includes a DB/LPM memory to store the set of LPM rules.

25. The method according to claim 16, wherein the LPM rules include forwarding information for forwarding a packet.

26. An article comprising:
a storage medium having stored thereon instructions that when executed by a machine result in the following:
receiving an input key;
performing a search to identify one of at least one section of a memory device in which to search for a resultant key having a longest prefix matching the input key and provide a memory reference; and
performing a Discriminant Bits (DB)/Longest Prefix Match (LPM) search based on the input key and the memory reference, and utilize a discriminant bits pattern and a set of LPM rules to determine and provide a determined key.

27. The article according to claim 26, wherein the determined key is selected from the group consisting of: (a) the resultant key having the longest prefix matching the input key if located in the memory device, and (b) a default key if the resultant key having the longest prefix matching the input key is not located in the memory device.

28. The article according to claim 26, wherein the search is a pipelined binary search of a set of memory banks.

29. The article according to claim 26, wherein the instructions further result in determining the at least one memory section of the memory device and placing an address from each of the at least one memory section into each of the memory banks.

30. The article according to claim 26, wherein the instructions further result in determining a next hop address by matching the determined key with a set of next hop addresses in an address look-up table.

31. The article according to claim 30, wherein the instructions further result in forwarding a packet associated with the input key to the next hop address.

32. The article according to claim 26, wherein the LPM rules include forwarding information for forwarding a packet.

33. A method, comprising:
adding a new key to a memory;
adding at least one dummy key to the memory if the new key is determined to nest an old key, in a set of old keys, and be nested by at least one of the old keys;
generating first Longest Prefix Match (LPM) rules for the new key;
updating second Longest Prefix Match (LPM) rules of any old key that is nested to the new key.

34. The method according to claim 33, wherein each of the first LPM rules and the second LPM rules contain forwarding information for forwarding a packet.

35. The method according to claim 33, wherein each of the old keys has its own pointer pointing to its second LPM rules.

36. The method according to claim 33, further including adding the first LPM rules and the second LPM rules to an LPM memory.

37. An article comprising:
a storage medium having stored thereon instructions that when executed by a machine result in the following:
adding a new key to a memory;
adding at least one dummy key to the memory if the new key is determined to nest an old key, in a set of old keys, and be nested by at least one of the old keys;
generating first Longest Prefix Match (LPM) rules for the new key;
updating second Longest Prefix Match (LPM) rules of any old key that is nested to the new key.

38. The article according to claim 37, wherein each of the first LPM rules and the second LPM rules contain forwarding information for forwarding a packet.

39. The article according to claim 37, wherein each of the old keys has its own pointer pointing to its second LPM rules.

40. The article according to claim 37, further including adding the first LPM rules and the second LPM rules to an LPM memory.

41. A system, comprising:
a memory device to store a plurality of old resultant keys;
a key adding device to receive a new resultant key;
a Longest Prefix Match (LPM) rule determining device to add the new resultant key to the memory device and add dummy keys to a set of Longest Prefix Match (LPM) rules, if the new resultant key nests any of the old resultant keys and the new resultant key is nested by any of the old resultant keys, and
update the LPM rules of all of the old resultant keys nested to the new resultant key; and
an LPM memory to store the LPM rules.

42. The system according to claim 41, wherein each of the first LPM rules and the second LPM rules contain forwarding information for forwarding a packet.

43. The system according to claim 41, wherein the new key and each old key of the set of old keys has its own pointer pointing to its LPM rules.

44. The system according to claim 41, wherein the LPM memory is housed within an address look-up device.

45. The system according to claim 41, wherein the LPM rules include information concerning a prefix length of a specific key, and a name of any of the old resultant keys to which the specific key is nested.

46. An address look-up device, comprising:
a pipelined binary search device to receive an input key and search a plurality of memory banks to determine a memory reference identifying one of at least one memory section of a memory device in which to search for a resultant key having a longest prefix matching the input key.

47. The address look-up device of claim 46, further including a processor to determine the at least one memory section of the memory device and place an address from each of the at least one memory section into each one of the memory banks.

48. The address look-up device of claim 46, wherein the memory device contains a address look-up table to store a next hop address for each of the resultant key and a default key.

49. The address look-up device of claim 48, further including a match device to match the determined key with the next hop address in the address look-up table.

50. An address look-up device, comprising:
a Discriminant Bits (DB)/Longest Prefix Match (LPM) search device to receive an input key and a memory reference, and to utilize a DB pattern and a set of LPM rules to determine and provide a determined key.

51. The address look-up device according to claim 50, wherein the determined key is selected from the group consisting of: (a) a resultant key, located in a memory device, having a longest prefix matching the input key, and (b) a default key if the resultant key having the longest prefix matching the input key is not located in the memory device.

52. The address look-up device of claim 50, wherein the DB/LPM search device includes a DB/LPM module to determine the DB pattern from a plurality of resultant keys stored in the memory device.

53. The address look-up device of claim 50, wherein the DB/LPM search device includes a DB/LPM memory to store the DB pattern and the set of LPM rules.

54. A method of performing a longest prefix match search based on a network address included in a network packet, the method comprising:
receiving the network address;
accessing a discriminant bit (DB) array derived from data corresponding to different network destination addresses, at least some of the network destination addresses differing in prefix length, and
based at least on the DB array, determining a longest prefix match for the received network address from the different network destination addresses.

55. The method of claim 54, wherein the determining of the longest prefix match includes utilizing data identifying nested the network destination addresses that share a common prefix.

56. The method of claim 54, wherein the determining of the network destination address includes a determination based on generation of at least one dummy key for the network destination addresses that share a common prefix.

57. The method of claim 54, further comprising, based on the received network address, determining a memory section from a plurality of memory sections that store the data corresponding to different network destination addresses.

58. The method of claim 54, further comprising, determining the DB array from the different network addresses.

59. The method of claim 54, wherein the received network address and the different network addresses comprise Internet Protocol addresses.
